(19) United States
(12) Patent Application Publication
(10) Pub. No.: US 2013/0022482 A1
(43) Pub. Date: Jan. 24, 2013

(54) NON-CIRCULAR BEARING AND A METHOD FOR ROTATING A CAM

(71) Applicant: Timothy M. SCHOBER, Beloit, WI (US)

(72) Inventor: Timothy M. SCHOBER, Beloit, WI (US)

(73) Assignee: SPX Corporation, Charlotte, NC (US)

(21) Appl. No.: 13/186,082

(22) Filed: Jul. 19, 2011

(51) Int. Cl. F16C 19/50; F04B 53/00

(52) U.S. Cl. 417/437; 384/447

(57) ABSTRACT

A bearing is provided. The bearing includes: an inner race; rolling elements located in an array around the inner race; and an outer race located around the inner race and the outer race is configured to retain the rolling elements between the inner and outer races, wherein at least one of the outer race and the rollers have an external profile that is a non-circular external profile and thereby configured to exert a linear motion in a radial direction to a work piece in contact with the external profile as the bearing rotates with respect to the work piece. A method of rotating a cam is provided. The method includes: rotating a bearing about a substantially constant center; and causing rolling elements in the bearing to rotate along a non-circular and circumference line and about the substantially constant center, wherein the circumference line has high portions and low portions wherein the high portions have a longer radial distance from the substantially constant center than the low portions.

### FIELD OF THE INVENTION

The present invention relates generally to roller bearings. More particularly, the present invention relates to an elliptical cam bearing for a hydraulic pump.

### BACKGROUND OF THE INVENTION

Ordinary pumps such as the type used as hydraulic pumps use a rotating cam to operate various cylinders located radially in an array about the cam. As the cam rotates, the rotational energy of the cam is transformed into linear movement of the pistons within the cylinders.

Currently this type of movement is done by an off-center eccentric actuator. The design of the radial piston pump actuation method has been through the use of a traditional circular bearing which is located off center from a rotating shaft. This arrangement causes vibration due to an imbalanced rotating mass and overhung loads.

Overhung loads can cause bending which may lead to fatigue failures. In these designs, to eliminate the vibration, a mass countering the imbalance is often used in such a system. However, this type of arrangement has a side effect of adding excess weight.

Accordingly, it is desirable to provide a method and apparatus that can translate rotational motion such as that from a rotational shaft into a linear motion of a piston moving through a cylinder without the drawbacks set forth above.

### SUMMARY OF THE INVENTION

In some embodiments, rotational motion such as a motion of rotating shaft is transformed into the linear motion of pistons moving through cylinders. This is done by use of an elliptical cam bearing rather than an eccentric. As a result, vibration and extra weight may be reduced.

In accordance with one embodiment of the present invention, a bearing is provided. The bearing includes: an inner race; rolling elements located in an array around the inner race; and an outer race located around the inner race and the outer race is configured to retain the rolling elements between the inner and outer races, wherein at least one of the outer race and the rollers have an external profile that is a non-circular external profile and thereby configured to exert a linear motion in a radial direction to a work piece in contact with the external profile as the bearing rotates with respect to the work piece.

In accordance with another embodiment of the present invention, a method of rotating a cam is provided. The method includes: rotating a bearing about a substantially constant center; and causing rolling elements in the bearing to rotate along a non-circular, circumference line and about the substantially constant center, wherein the circumference line has high portions and low portions wherein the high portions have a longer radial distance from the substantially constant center than the low portions.

In accordance with yet another embodiment of the present invention, a bearing is provided. The bearing includes: an inner retaining means; a means for rolling located in an array around the inner retaining means; and an outer retaining means located around the inner retaining means and the outer retaining means configured to retain the means for rolling between the inner and outer retaining means, wherein at least one of the outer retaining means and the rolling means have an external profile that is a non-circular external profile and thereby configured to exert a linear motion in a radial direction to a work piece in contact with the external profile as the bearing rotates with respect to the work piece.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a cam bearing in accordance with a preferred embodiment of the invention.

FIG. 2 is a perspective exploded view of the cam bearing illustrated in FIG. 1.

FIG. 3 is a perspective view of the cam bearing shown in FIGS. 1 and 2 installed in a portion of a piston pump.

FIG. 4 is a partial front view of the cam bearing and the piston pump shown in FIG. 3.

### DETAILED DESCRIPTION

The invention will now be described with reference to the drawing figures, in which like reference numerals refer to like parts throughout. An embodiment in accordance with the present invention provides a cam bearing having a non-circular external profile that, when rotated, acts as a cam to actuate pistons within a piston pump.

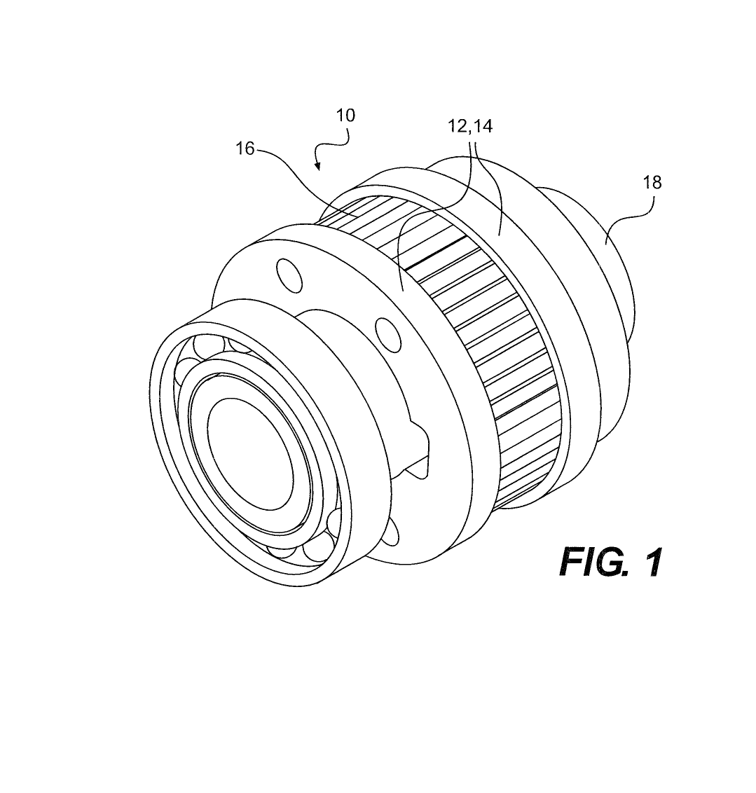

FIG. 1 illustrates a cam bearing 10 in accordance with an embodiment of the present invention. The cam bearing 10 includes an outer race 12, 14. As shown in FIG. 1, the outer race 12, 14 is in two parts 12 and 14. The bearing 10 also includes rolling elements 16 and the bearing 10 is mounted onto a shaft 18. The shaft 18 is not necessary part of the bearing 10, but illustrates environmental structure upon which the bearing 10 may be mounted.

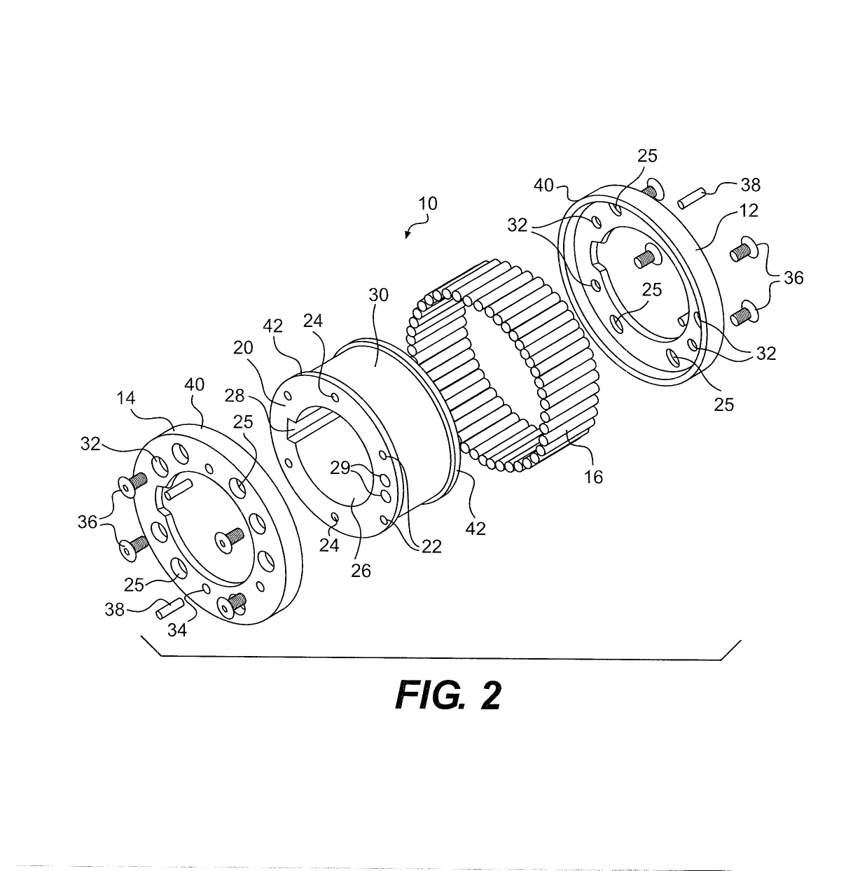

FIG. 2 is a perspective exploded view of the bearing 10 illustrated in FIG. 1. The bearing 10 includes an inner race 20. The inner race 20 includes fastener holes 22 and pin holes 24. Fastener holes 22 may have internal threads. The inner race 20 may also include an opening 26. The opening 26 may allow the inner race to be mounted on a shaft 18 as shown in FIG. 1. The opening 26 may be generally circular and may also have a keyway 28. Keyway holes 29 offset the material removed by the keyway 28. Thus, the keyway holes 29 help counter-balance the inner race 20.

The inner race 20 has a non-circular bearing surface 30. The bearing surface 30 provides a surface for the rolling elements 16 to contact and move along the inner race 20. In some embodiments of the invention, the bearing surface 30 is non-circular. The bearing surface 30 may define a non-circular external profile around the circumference of the inner race 20. The non-circular external profile defined by the bearing surface 30 may be a variety of shapes.

As shown in FIG. 2, the bearing surface 30 is shaped as an ellipse. Thus, the rolling elements 16 arranged around the elliptical bearing surface 30 form an elliptical shape.

The outer races 12 and 14 are also elliptical shape to match the shape of the inner race 20. The outer races 12 and 14 have fastener holes 32, pin holes 34 and lubrication holes 25. The lubrication holes 25 provide a flow path for lubricant to flow into the rolling elements 16 and the inner race 20 of the bearing.

When the elliptical bearing 10 is assembled, the rolling elements 16 are arranged around the elliptical bearing surface 30 and are held in place by the outer races 12 and 14. The outer races 12 and 14 are secured to the inner race 20 by fasteners 36 extending through the fastener holes 32 and 22. The fasteners 36 may have external threads which correspond to the internal threads in the fastener holes 22. The fastener holes 32 may also have internal threads.

Pins 38 may also be placed into the pin holes 34 and 24. The pins 38 may be sized so that they fit into the pin holes 34 and 24 by a friction fit or an interference fit.

The outer races 12 and 14 may also be equipped with a retaining lip 40 to assist in orienting the outer races 12 and 14 on the inner race 20. The retaining lip 40 may also assist in retaining the rolling elements 16. The inner race 20 may also have flanges 42 which help maintain the rolling elements 16 in a desired location and/or orientation about the bearing surface 30. The rolling elements 16 may be standard needle bearings that may be readily available on the market.

In some embodiments of the invention, enough rolling elements 16 are used to substantially fill the space between the outer races 12 and 14 and the inner race 16 around the bearing surface 30.

As shown in FIG. 1, when the rolling elements 16 are arranged around the elliptical bearing surface 30 of the inner race 20, the rolling elements 16 define a non-circular external profile similar to that of the bearing surface 30. The figures illustrate a non-circular or external profile with shape of an ellipse. Other external profiles may be used and may be adapted by one of ordinary skill in the art for particular needs. After reviewing this disclosure one of ordinary skill in the art can select an external profile that would be useful for a particular application.

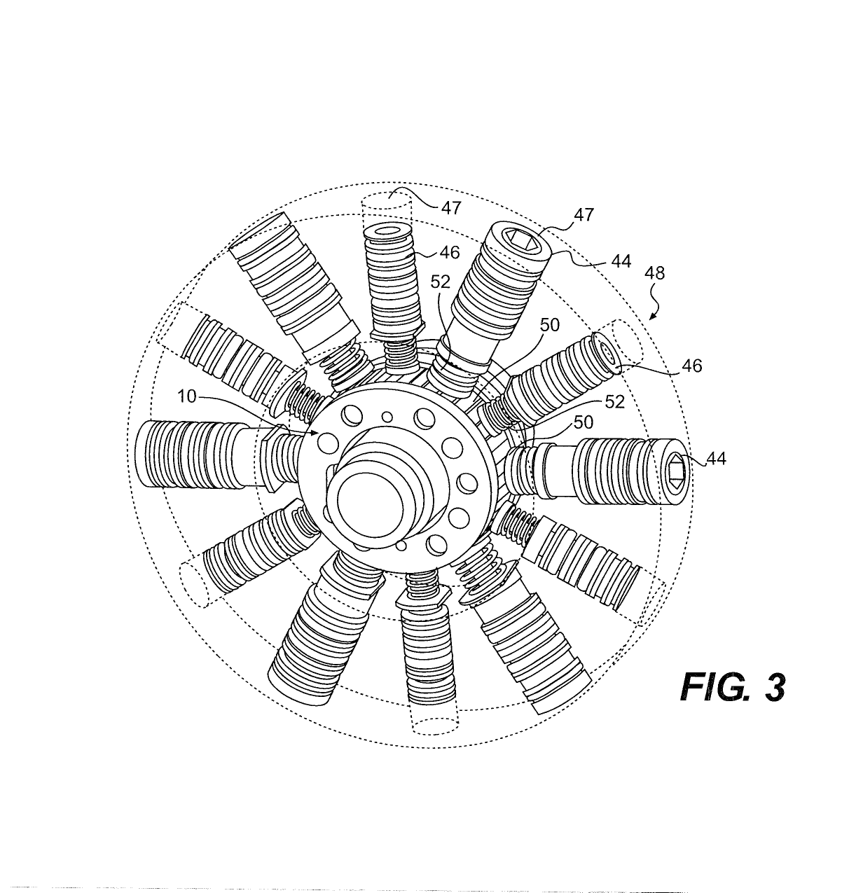

Turning now to FIG. 3, the elliptical bearing 10 is shown fit into a portion of a piston pump 48. The piston pump 48 includes large pistons 44 and smaller pistons 46 located in cylinders 47 located in an array around the elliptical bearing 10. In some embodiments of the invention, and as shown in FIG. 3, large pistons 44 and smaller pistons 46 are arranged in an alternating manner about the elliptical bearing 10. Both the large pistons 44 and the smaller pistons 46 have contact surfaces 50 that urge against the rolling elements 16.

Springs 52 urge the contact surfaces 50 to move in the radial direction inward toward the rolling elements 16. Therefore, the contact surfaces 50 are pressed against a non-circular external profile defined by the rolling elements 16.

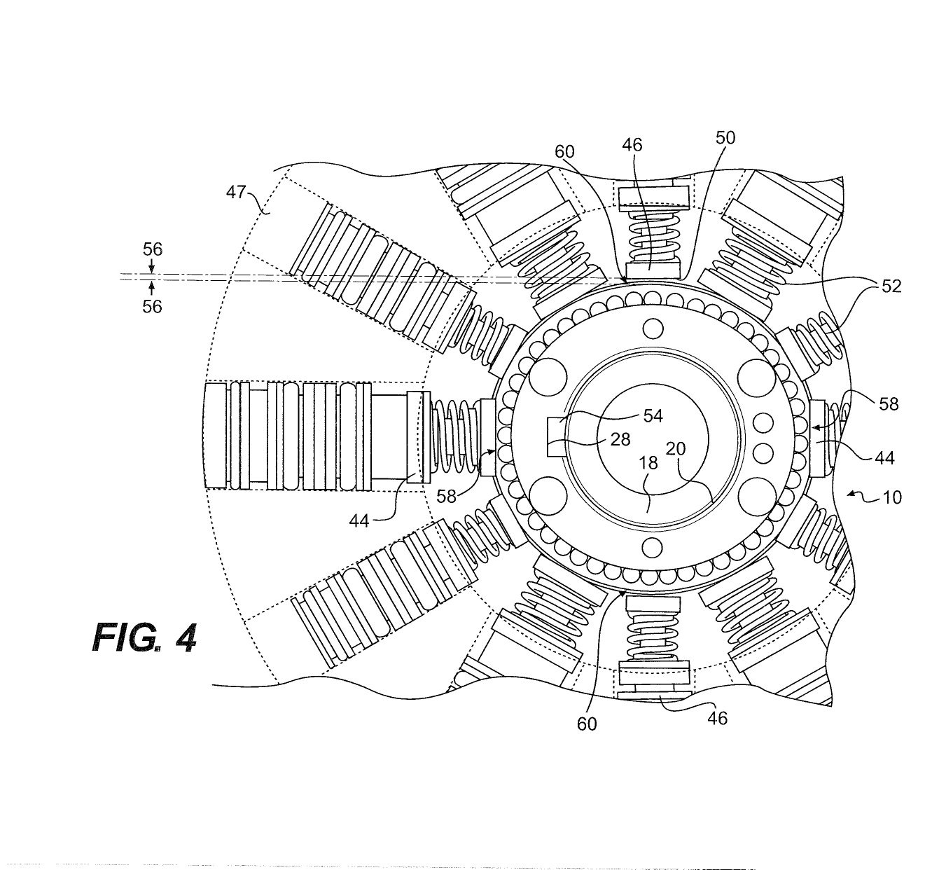

FIG. 4 illustrates a partial front view of the pump 48 shown in FIG. 3. The elliptical bearing 10 is mounted onto a shaft 18. A key 54 in the shaft 18 is located in the keyway 28 of the inner race 20. The contact surfaces 50 of the large 44 and smaller pistons 46 are shown to be spaced from the rolling element 16. This is done for clarity, but in ordinary applications the contact surfaces 50 would be urged by the springs 52 to press against the rolling elements 16.

An non-circular shape of the external profile of the elliptical bearing 10 provides a high profile 58 and a low profile 60. In the case of the non-circular external profile being and ellipse as shown in FIG. 4, there are two high profiles 58 and two low profiles 60. Thus, a complete revolution of the elliptical bearing 10 will cause two high profiles 58 and to low profiles 60 to urge against the contact surfaces 50. Thus, each pistons 44 and 60 will move up and down twice per rotation of the bearing 10 within each cylinder 47. The lines and the arrows illustrated at numeral 56 illustrate the difference between the high 58 and the low profile 60. One of ordinary skill in the art after reviewing this disclosure could select a desired external profile to achieve a desired difference 56 in light of the high 58 and low profile 60 for a particular application.

In some embodiments in accordance with the invention and as shown in the FIGS., the high profile 58 and the low profile 60 could be spaced to be about 180° from each other, or in other words, on opposite sides of the elliptical bearing 10 from each other. Thus, a piston 46 contacting the low profile 60 would be in direct opposition to another piston 46 also contacting the other low profile 60 and a piston 44 contacting a high profile 58 would be directly opposite to, or about a 180° from, a second piston 44 also contacting the high profile 58.

Balancing the high profile 58 and the low profile 60 provides a more even distribution of the load. Balancing the high 58 and low profiles 60 to provide opposing load support which should mitigate vibration as the elliptical bearing 10 is rotated. Balancing should also greatly reduced or eliminating shaft bending. While the FIGS. should show only two high 58 profiles and two low profiles 60, other combinations of high 58 and low profiles 60 may be used and may be balanced in accordance with other embodiments of the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A bearing comprising:
an inner race;
rolling elements located in an array around the inner race; and
an outer race located around the inner race and the outer race is configured to retain the rolling elements between the inner and outer races,
wherein at least one of the outer race and the rollers have an external profile that is a non-circular external profile and thereby configured to exert a linear motion in a radial direction to a work piece in contact with the external profile as the bearing rotates with respect to the work piece.

2. The bearing of claim 1, wherein the external profile is elliptical.

3. The bearing of claim 1, wherein the inner race has a bearing surface configured to contact the rolling elements located between two flanges.

4. The bearing of claim 3, wherein the our race is comprised of two parts wherein each part fits over one of the flanges of the inner race thereby trapping the rolling elements between the inner and outer races.

5. The bearing of claim 1, wherein the inner race has a generally circular hole wherein the center of the generally circular hole is located at the approximate located of the centriod of the inner race.

6. The bearing of claim 5, wherein the inner race defines a keyway in the generally circular hole.

7. The bearing of claim 1, wherein the external profile has multiple long radius portions and short radius portions.

8. The bearing of claim 7, wherein two long radius portions are located about 180° from each other.

9. The bearing of claim 7, wherein two short radius portions are located about 180° from each other.

10. The bearing of claim 1, wherein the bearing is mounted on a shaft in a piston pump, and the pistons are connected to the bearing so that as the bearing rotates, a high portion of the external profile causes the piston to move radially away from the bearing and the low portion of the external profile allows the piston to move radially toward the bearing.

11. The bearing of claim 10, wherein a portion of the piston that contacts the bearing contacts the rolling elements.

12. The bearing of claim 1, wherein the inner race has an outer profile substantially similar to the non-circular outer profile.

13. The bearing of claim 1, wherein substantially all space between the inner race and the outer race is taken up by the rolling elements.

14. The bearing of claim 1, wherein the outer race defines lubrication holes dimensioned to allow lubricant to flow through the holes to at least one of: the inner race and the rolling elements.

15. A method of rotating a cam comprising:
rotating a bearing about a substantially constant center; and
causing rolling elements in the bearing to rotate along a non-circular, circumference line and about the substantially constant center,
wherein the circumference line has high portions and low portions wherein the high portions have a longer radial distance from the substantially constant center than the low portions.

16. The method of claim 15, wherein the circumference line is an ellipse.

17. The method of claim 15, further comprising urging a work piece against the circumference line and causing the work piece to move linearly in a radial direction as the work piece moves against the high and low portions.

18. The method of claim 17, further comprising urging more than one work piece against the circumference line and balancing the work pieces by having more than one work piece move against the high side at the same time.

19. The method of claim 17, further comprising exposing the rolling elements to the work piece.

20. A bearing comprising:
an inner retaining means;
a means for rolling located in an array around the inner retaining means; and
an outer retaining means located around the inner retaining means and the outer retaining means configured to retain the means for rolling between the inner and outer retaining means,
wherein at least one of the outer retaining means and the rolling means have an external profile that is a non-circular external profile and thereby configured to exert a linear motion in a radial direction to a work piece in contact with the external profile as the bearing rotates with respect to the work piece.
